(19) United States
(12) Patent Application Publication
(10) Pub. No.: US 2026/0310299 A1
(43) Pub. Date: Oct. 8, 2026

(54) THREE-DIMENSIONAL SOFT COMPLIANT ARRAY TACTILE SENSOR WITH MULTI-MODAL SENSING AND SCALABLE MANUFACTURING METHODS

(71) Applicant: Tesla, Inc., Austin, TX (US)

(72) Inventors: Hung Sheng LIN, Palo Alto, CA (US); Nitin SITARAMAN, San Jose, CA (US); Yi Quan XIONG, Palo Alto, CA (US); Mohammed AI-RUBAIAI, Mountain View, CA (US); Ruoyu XU, Los Gatos, CA (US); Siddharth RUPAVATHARAM, Mountain View, CA (US); Jeremy EICHHORN, San Francisco, CA (US); Jessica WEI, Palo Alto, CA (US); Jooyeun HAM, Palo Alto, CA (US); Yongguo LEE, Gilroy, CA (US); Gaurav CHANDRA, San Jose, CA (US); Sagar Nagsandra RANGASWAMAIAH, Mountain View, CA (US)

(73) Assignee: Tesla, Inc., Austin, TX (US)

(21) Appl. No.: 19/326,524

(22) Filed: Sep. 11, 2025

Related U.S. Application Data
(60) Provisional application No. 63/783,580, filed on Apr. 4, 2025.

(51) Int. Cl. G06F 3/01; G06F 3/044

(52) U.S. Cl. CPC G06F 3/016; G06F 3/014; G06F 3/0446; G06F 2203/04103

(57) ABSTRACT

Disclosed herein are three-dimensional (3D) tactile sensors and methods for manufacturing the same. A method includes providing a first substrate material for the 3D tactile sensor, defining a set of first conductive regions for the 3D tactile sensor on the first substrate material, coupling a separator layer between the first substrate material including the set of first conductive regions and a second substrate material having a set of second conductive regions to create a stack, and forming the stack according to a target 3D structure. The substrate materials can include flexible polymers, and the conductive regions can be defined by processes such as screen printing, etching, laser-direct structuring, pad-printing, or 3D deposition. The separator layer can comprise a dielectric or piezoresistive material. The 3D tactile sensors can conform to curved geometries and can be used for measuring surface force, touch, and pressure.

### CROSS-REFERENCE TO RELATED PATENT APPLICATIONS

The present application claims priority to U.S. Provisional Application No. 63/783,580, filed Apr. 4, 2025, which is incorporated by reference in its entirety for all purposes.

### TECHNICAL FIELD

The present disclosure relates to tactile sensing systems, specifically three-dimensional (3D) soft compliant tactile sensors capable of measuring surface force, touch, and pressure across curved geometries.

### BACKGROUND

Tactile sensors are used to detect physical interactions such as contact, force, and pressure in various environments. Achieving high spatial resolution and mechanical compliance in tactile sensing remains challenging.

Conventional rigid, two-dimensional (2D) tactile sensors lack the ability to conform to curved or irregular geometries, which can result in decreased sensitivity or unreliable detection of contact, force, or pressure in various applications. For example, as autonomous robotics systems become more prevalent, there exists a need for tactile sensors to conform to the contours or geometries of robotics equipment.

### SUMMARY

The techniques described herein provide three-dimensional (3D) tactile sensors capable of measuring surface force, touch, and pressure across curved geometries. Such sensors can be used in a variety of applications, including, but not limited to, robotics systems or automation systems. For example, the 3D tactile sensors described herein can be used in fingertips, palms, end-effectors, or other portions of a robot enabling the robot to sense the world around it. The sensors may be defined using flexible or formable material, such as thermoplastic, and can support resistive or capacitive sensing. The 3D tactile sensors described herein can be manufactured using a variety of approaches. One example approach involves defining an array of sensing elements in a substrate material using screen printing or substrate etching. Additional approaches involve the use of 3D dispensing (e.g., 3D printing) techniques, pad printing techniques, or electroplating techniques. The substrate may be formed to a target 3D geometry using thermoforming, injection molding, or compression molding, among any other suitable techniques.

At least one aspect is related to a method that can include providing a first substrate material for a three-dimensional tactile sensor. The method can include defining a set of first conductive regions for the three-dimensional tactile sensor on the first substrate material. The method can include coupling a separator layer between the first substrate material including the set of first conductive regions and a second substrate material having a set of second conductive regions to create a stack. The method can include forming the stack into a target three-dimensional structure.

In some implementations, providing the first substrate material can include selecting the first substrate material from thermoplastic polyurethane, polyethylene terephthalate, or polyimide. In some implementations, defining the set of first conductive regions can include disposing a conductive ink on a surface of the first substrate material, the conductive ink forming the set of first conductive regions. In some implementations, disposing the conductive ink can include using a screen-printing process and a stencil defining a pattern of traces for the three-dimensional tactile sensor.

In some implementations, defining the set of first conductive regions can include etching a channel in the first substrate material corresponding to a pattern of traces for the three-dimensional tactile sensor and providing a conductive material in the channel. In some implementations, etching the channel can include cutting a portion of the first substrate material using a laser. In some implementations, the method can further include providing a cover layer over the conductive material, the cover layer exposing at least a portion of the conductive material. In some implementations, the method can further include coupling a flexible printed circuit board to at least a portion of the set of first conductive regions. In some implementations, forming the stack into a target three-dimensional structure can include thermoforming the stack using a mold for the target three-dimensional structure.

At least one other aspect relates to a method that can be performed, for example, by one or more processors coupled to non-transitory memory. The method can include forming a first substrate material according to a target three-dimensional structure for a three-dimensional tactile sensor. The method can include defining a set of first conductive regions for the three-dimensional tactile sensor on the first substrate material. The method can include providing a separator material over at least a portion of the set of first conductive regions. The method can include coupling a second substrate material having a set of second conductive regions to the separator material, the second substrate material conforming to a three-dimensional structure of the first substrate material.

In some implementations, forming the first substrate material according to the target three-dimensional structure can include thermoforming a layer of the first substrate material using a mold corresponding to the target three-dimensional structure of the three-dimensional tactile sensor. In some implementations, defining the set of first conductive regions can include depositing one or more conductive traces on a surface of the first substrate material using a three-dimensional dispensing process. In some implementations, defining the set of first conductive regions can include defining one or more activated regions on a surface of the first substrate material and plating the one or more activated regions with a conductive material.

In some implementations, defining the one or more activated regions can include using a laser according to a pattern of traces for the three-dimensional tactile sensor. In some implementations, defining the set of first conductive regions can include providing one or more conductive traces on a surface of the first substrate material using a pad printing process. In some implementations, providing the separator material can include depositing the separator material on the portion of the set of first conductive regions using a three-dimensional dispensing process. In some implementations, providing the separator material can include coupling a layer of dielectric material to the first substrate material to cover the set of first conductive regions. In some implementations, the method can further include mounting one of the first substrate material or the second substrate material to a backing material.

At least one aspect relates to a three-dimensional tactile sensor that can include a stack comprising a first layer of substrate material having a set of first conductive regions, a separator material coupled to the first layer of substrate material, and a second layer of substrate material having a set of second conductive regions isolated from the set of first conductive regions by the separator material. The stack is thermoformed to conform to a target three-dimensional structure.

In some implementations, the separator material comprises one of a dielectric material or a piezoresistive material.

These and other aspects and implementations are discussed in detail below. The foregoing information and the following detailed description include illustrative examples of various aspects and implementations and provide an overview or framework for understanding the nature and character of the claimed aspects and implementations. The drawings provide illustration and a further understanding of the various aspects and implementations and are incorporated in and constitute a part of this specification. Aspects can be combined, and it will be readily appreciated that features described in the context of one aspect of the invention can be combined with other aspects. As used in the specification and in the claims, the singular form of “a,” “an,” and “the” include plural referents unless the context clearly dictates otherwise.

### BRIEF DESCRIPTION OF THE DRAWINGS

Non-limiting embodiments of the present disclosure are described by way of example concerning the accompanying figures, which are schematic and are not intended to be drawn to scale. Unless indicated as representing the background art, the figures represent aspects of the disclosure.

FIG. 1 is a diagram showing robotic hand equipped with 3D soft compliant array tactile sensor, according to an embodiment.

FIG. 2 shows a perspective view of a 3D tactile sensor mounted on a backing material, according to an embodiment.

FIG. 3 shows a flow chart of a method for fabricating a 3D tactile sensor by creating a layer stack and applying a thermoforming process thereto, according to an embodiment.

FIGS. 4A, 4B, and 4C show diagrams of a 3D screen-printing process for defining conductive ink on substrate material used to create the 3D tactile sensors described herein, according to an embodiment.

FIG. 4D shows a top view of a substrate with screen-printed conductive regions for a 3D tactile sensor formed using the techniques shown in FIGS. 4A, 4B, and 4C, according to an embodiment.

FIG. 4E shows a cross-sectional view of a layer stack including the substrate material and conductive regions of FIG. 4D coupled to a separator material, according to an embodiment.

FIGS. 5A, 5B, 5C, 5D, and 5E show diagrams of an example process for forming a layer stack using an etching process, according to an embodiment.

FIG. 6 shows a diagram of a thermoforming process for shaping a layer stack formed according to the techniques described herein, according to an embodiment.

FIG. 7 shows a cross-sectional view of a 3D tactile sensor following the thermoforming process of FIG. 6, according to an embodiment.

FIG. 8 shows a flow chart of a method for manufacturing a 3D tactile sensor by forming a conformal base substrate and depositing conductive traces and separator material thereon, according to an embodiment.

FIG. 9 shows a diagram of a 3D dispensing process for forming conductive traces on a formed substrate material, according to an embodiment.

FIGS. 10A and 10B show diagrams of a process for defining conductive regions on a formed substrate material using a laser, according to an embodiment.

FIGS. 11A and 11B show diagrams of a process for defining conductive regions on a formed substrate material using a pad printing process, according to an embodiment.

FIG. 12A shows a diagram showing a 3D dispensing process for forming separator material on conductive regions defined on a substrate material, according to an embodiment.

FIG. 12B shows a diagram of a 3D tactile sensor formed after deposition of the separator material as shown in FIG. 12A, according to an embodiment.

### DETAILED DESCRIPTION

Reference will now be made to the illustrative embodiments depicted in the drawings, and specific language will be used here to describe the same. It will nevertheless be understood that no limitation of the scope of the claims or this disclosure is thereby intended. Alterations and further modifications of the inventive features illustrated herein, and additional applications of the principles of the subject matter illustrated herein, which would occur to one skilled in the relevant art and having possession of this disclosure, are to be considered within the scope of the subject matter disclosed herein. Other embodiments may be used and/or other changes may be made without departing from the spirit or scope of the present disclosure. The illustrative embodiments described in the detailed description are not meant to be limiting to the subject matter presented.

Tactile sensing systems, such as robotics systems, may use force or pressure sensors to measure contact with a physical environment. For example, tactile sensing can be used in robotic end-effectors, wearable devices, or other surfaces of automated systems that interact with physical objects or environments. Existing tactile sensors are limited to two-dimensional (2D), flat configurations that do not mechanically comply with 3D geometries. Such rigid, 2D sensors therefore cannot be used in a variety of robotics applications, including those that require sensors on end-effectors, robotic hands, or other curved surfaces. Existing soft tactile sensors lack mechanical stability, making them unsuitable for many applications.

The techniques described herein can be used to manufacture 3D tactile sensors that are not limited to rigid, 2D geometries while providing mechanical stability suitable for robotics or automation systems. Tactile sensors manufactured using such techniques can include both resistive and capacitive sensors. To manufacture such sensors, a flexible array of conductive regions can be defined in a formable substrate material. The conductive regions may be defined using any suitable technique, including but not limited to screen printing, deposition of conductive paste, laser-direct structuring, or pad printing. The formable substrate material can be coupled to a separator material, which may include a dielectric material for capacitive sensors or a piezoresistive material for resistive sensors. The separator material may separate complementary layers of substrate material that are each defined according to target capabilities and area of the sensors.

The 3D tactile sensors may be defined as capacitive or resistive sensors. Capacitive sensors can include conductive regions disposed on substrate layers separated by a dielectric separator material. The substrate and dielectric separator material may be flexible or pliable, such that in response to an applied force, the dielectric separator material can compress and decrease the distance between the conductive regions on the substrate layers. The change in distance results in a change in capacitance. Resistive sensors operate similarly using a piezoresistive separator material. The piezoresistive separator material can change in resistance in response to mechanical deformation. In response to an applied force, the piezoresistive separator material can deform such that the electrical resistance between the conductive regions on the substrate layers decrease. The change in resistance or capacitance can be detected by readout circuitry electrically coupled to the conductive regions of the sensor.

Thermoforming may be used to conform the layers of substrate material and separator material to a target 3D geometry. The target 3D geometry may be a desired shape or contour of a robotics or automation system. For example, the layer stack making up the tactile sensor may be formed according to a 3D geometry of a palm, finger, or end-effector of a robot. The layer stack making up the 3D sensor may be formed to conform to an outer layer of a robotic housing, for example, to operate as a tactile “skin” for a humanoid robot. Any suitable technique may be used to form the sensors described herein to any suitable geometry for any application involving tactile sensors.

In some implementations, the 3D tactile sensors described herein may be formed into a target 3D geometry prior to defining conductive regions to substrate material. For example, a layer of substrate material can first be thermoformed, molded, or otherwise defined to conform to a target 3D geometry for the tactile sensor. Plating (e.g., electroplating) or deposition techniques can be used to define conductive regions for the sensors on the surface of the formed substrate material. A separator material, which may include a dielectric material or a piezoresistive material, can then be defined (e.g., as a layer, via deposition, etc.) on the conductive regions. Another layer of the substrate material, which can have a corresponding set of conductive regions, can be coupled to or defined on the separator material to form the sensor. The additional layer of substrate material may be formed or deposited according to any of the techniques described herein.

The sensors described herein can be manufactured to include connectors that couple to the conductive regions formed on the layers of substrate material, to connect the sensors to suitable circuitry that detects changes in electrical characteristics of the sensor to detect contact, pressure, or forces applied to the sensor. Such connectors can include zero insertion force (ZIF) connectors, anisotropic conductive film coupled to the sensors, or solder coupling the sensors to a flexible printed circuit board (PCB). In some implementations, the connectors can be coupled to one or more conductive regions using a lamination process or may be formed in part during definition of the conductive regions on the substrate material.

The 3D tactile sensors manufactured according to the techniques described herein can be mounted to a backing material. In some implementations, the 3D tactile sensors can be mounted on a hard substrate, such as a plastic or metal base. In some implementations, the 3D tactile sensors can be mounted on a soft substrate, such as a foam, thermoplastic elastomer, or silicone material, by over-molding or adhesive bonding such that the 3D tactile sensors maintain mechanical compliance. One or more protective layers can be applied over the 3D tactile sensors after mounting on the backing material. The protective layers can be flexible or compliant material such as foam, and can shield the sensors from environmental factors, mechanical wear, or impacts.

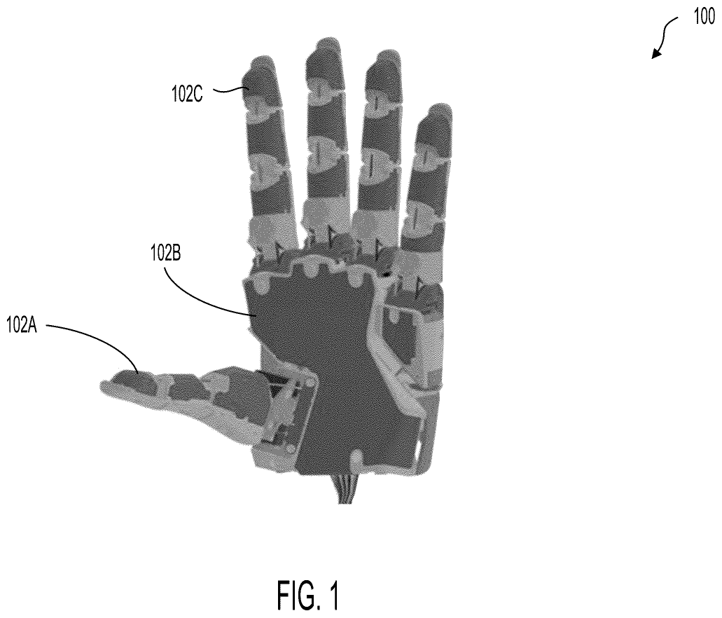

Referring to FIG. 1, illustrated is a diagram showing a robotic hand 100 including a set of 3D tactile sensors 102A, 102B, and 102C (sometimes generally referred to as the “3D tactile sensor(s) 102”), in accordance with one or more implementations. In this example, the first tactile sensor 102A is positioned along the thumb region of the robotic hand 100. The first tactile sensor 102A conforms to the geometry of the thumb, as shown. The second tactile sensor 102B is disposed on the palm region of the robotic hand 100. The second tactile sensor 102B can be arranged to cover a substantial portion of the palm surface such that tactile interactions occurring across the palm can be detected.

The 3D third tactile sensor 102C is shown as positioned on the index finger of the robotic hand 100. Additional sensors, similar to the 3D tactile sensors 102, can be positioned on any part of the robotic hand 100. Although this example is shown as providing 3D tactile sensors 102 on a robotic hand 100, it should be understood that the various sensors described herein may be provided on any type of surface for any suitable application. The 3D tactile sensors 102 may include one or more connectors, contacts, or connections to circuitry used to monitor the electric characteristics (e.g., capacitance, resistance, etc.) of the circuit. Each of the 3D tactile sensors 102 may include any number of “pixels” or regions that can independently detect physical contact.

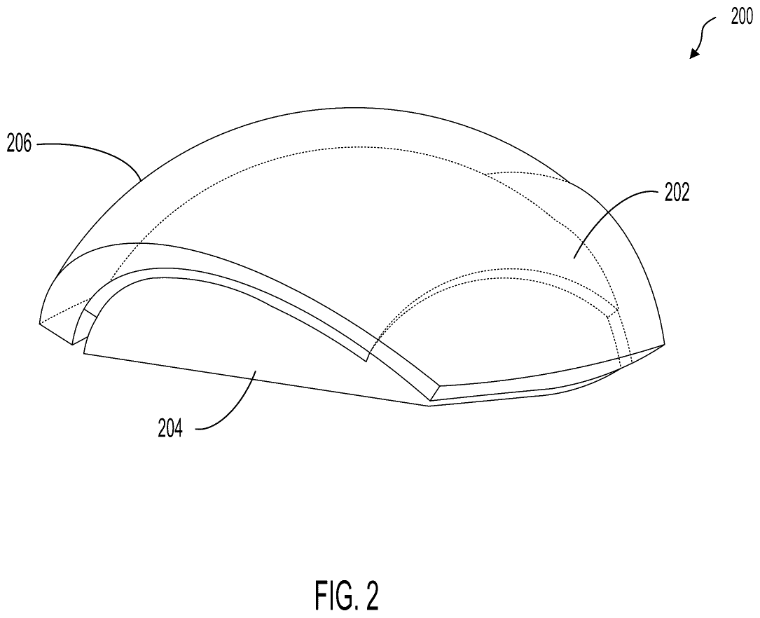

In some implementations, the 3D tactile sensors 102 can be integrated into a flexible “skin” layer that covers a robot, an autonomous vehicle, or any other type of system that operates in an environment to detect physical contact or pressure events. The 3D tactile sensors 102 can be manufactured according to the techniques described herein to occupy any suitable area while conforming to the 3D structure to which it is mounted. The 3D tactile sensors 102 may be coupled to one or more backing materials that provide structure for the 3D tactile sensors 102. Further details of example backing materials for the 3D tactile sensors described herein are described in connection with FIG. 2.

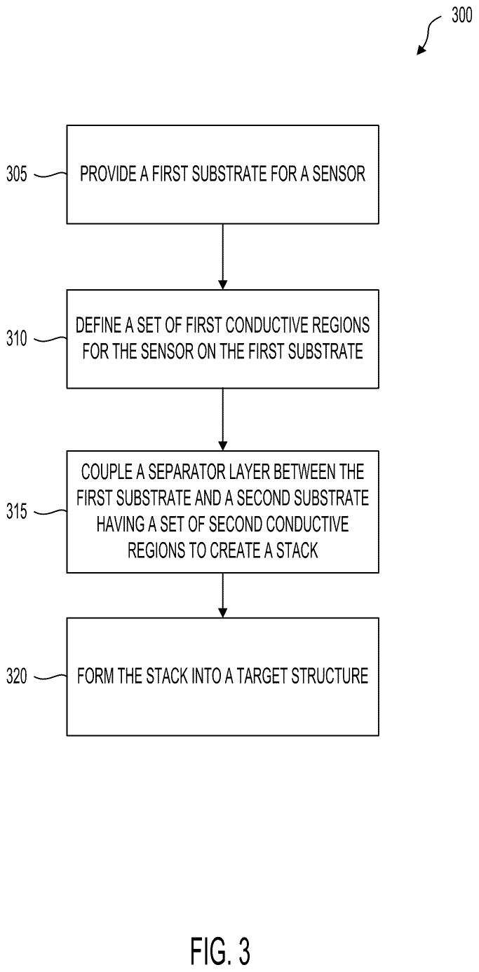

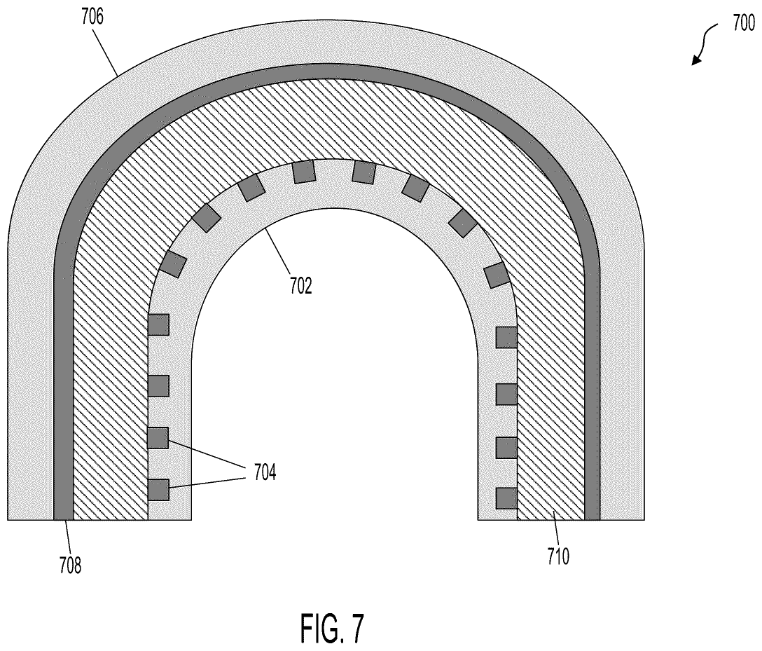

Referring to FIG. 2, illustrated is a perspective view 200 of an example 3D tactile sensor 202 mounted on a backing material 204, in accordance with one or more implementations. The 3D tactile sensor 202 may be manufactured using any of the techniques described herein, including the techniques described in connection with the method 300 of FIG. 3 and the method 800 of FIG. 8. The 3D tactile sensor 202 may be similar to, and include any of the structure or implement any of the functionality of, the 3D tactile sensors 102A, 102B, or 102C of FIG. 1. The 3D tactile sensor 202 may be or include one or more capacitive sensors or resistive sensors.

As shown, the 3D tactile sensor 202 has a curved shape that conforms to the geometry of the backing material 204. In some implementations, the 3D tactile sensor 202 can be coupled to the backing material 204 by adhesive bonding, overmolding, or mechanical fastening, among other approaches. For example, the 3D tactile sensor 202 can be coupled to the backing material 204 using a layer of a suitable adhesive. In another example, the 3D tactile sensor 202 can be positioned on the backing material 204 and overmolded (e.g., using thermoforming or similar approaches) to conform and bind the 3D tactile sensor 202 to the backing material 204. In some implementations, the 3D tactile sensor 202 can be attached to the backing material 204 by mechanical fasteners.

The backing material 204 can include materials selected based on the desired mechanical properties or application requirements. In some implementations, the backing material 204 can be formed from hard materials such as rigid plastic or metal. In some implementations, the backing material 204 can be formed from soft or compliant materials such as foam, thermoplastic elastomer (TPE), or silicone, among other materials. The backing material 204 can be produced by molding, thermoforming, or machining processes when using hard materials. When using soft or compliant materials, the backing material 204 can be produced by casting, molding, or forming processes

### (e.g., Thermoforming).

The 3D tactile sensor 202 is shown as being coupled to a protective layer 206. The protective layer 206 can include a material such as foam, thermoplastic polyurethane (TPU), silicone, or TPE, among others. The protective layer 206 can be formed by any suitable process, including but not limited to overmolding, adhesive coupling, casting, or attachment via one or more connectors or fasteners. In some implementations, the protective layer 206 can be deposited as a conformal coating or can be laminated as a layer of material. The protective layer 206 may have a uniform thickness or a variable thickness. In some implementations, the protective layer 206 can provide a barrier to moisture, dust, mechanical abrasion, or other external factors that may influence the operation of the 3D tactile sensor 202. The material for the protective layer 206 can be selected such that the mechanical compliance of the 3D tactile sensor 202 is maintained. In some implementations, the protective layer 206 may be patterned to expose selected regions of the 3D tactile sensor 202 for electrical interfacing or to allow direct contact with a target surface.

Referring to FIG. 3, illustrated is a flow chart of a method 300 for fabricating one or more 3D tactile sensors, in accordance with one or more implementations. The method 300 may be performed to create a layer stack in which layers of substrate material including conductive regions that define the sensing locations are separated by a separator material. The layer stack can then be molded or otherwise formed to conform to a target 3D geometry for the 3D tactile sensor. The method 300 may be performed to create any of the 3D tactile sensors described herein, including but not limited to the 3D tactile sensors 102A, 102B, and 102C of FIG. 1 and the 3D tactile sensor 202 of FIG. 2. In brief overview of the method 300, the method 300 can include providing a first substrate for a sensor (STEP 305), defining a set of first conductive regions for the sensor on the first substrate (STEP 310), coupling a separator layer between the first substrate and a second substrate having a second set of conductive regions (STEP 315), and forming the first substrate, the second substrate, and the separator layer into a target structure (STEP 320).

The method 300, at STEP 305, can include providing a first substrate for a sensor. In some implementations, the first substrate can be provided as a layer that can serve as a base for defining conductive regions. The first substrate material can be selected from a group of flexible or formable materials such as TPU, polyethylene terephthalate (PET), or polyimide, among other thermoplastic materials. The first substrate can be provided in a sheet or film form, such that the surface of the first substrate can receive conductive ink, conductive paste, or other conductive materials in subsequent processing steps. In some implementations, the first substrate can undergo surface treatment, such as plasma treatment or corona treatment, to modify the adhesion properties of the surface prior to the definition of conductive regions.

In some implementations, the layer or film of the first substrate material can be cut or etched to predetermined dimensions prior to defining conductive regions thereon in subsequent steps. For example, the first substrate material may be subjected to mechanical cutting, die cutting, chemical etching, or laser cutting, among other cutting approaches. The predetermined dimensions can be determined according to the target 3D geometry for the 3D tactile sensor. The layer or film of the first substrate material may be cut into a shape corresponding to the 3D structure to which it will conform. In some implementations, the first substrate may be cut or otherwise modified to include alignment holes, channels, or notches, among others, to facilitate subsequent assembly steps or attachment or mounting to other substrates, components, or structures.

The method 300, at STEP 310 can include defining a set of first conductive regions for the sensor on the first substrate. The set of first conductive regions can include traces or patterned features that define sensing regions for the 3D tactile sensor. In subsequent steps of the method 300, the conductive regions defined on the first substrate can be aligned with corresponding conductive regions on a second substrate layer, with the first and second substrate layers separated by separation material. In some implementations, the separation material may include a dielectric material and can create capacitive sensors between the conductive regions on the first and second layers of substrate material. In some implementations, the separation material may include a piezoresistive material and can create resistive sensors between the conductive regions on the first and second layers of substrate material. In some implementations, the set of first conductive regions can be defined on the first substrate using any of the techniques described in connection with STEP 810 of the method 800 of FIG. 8.

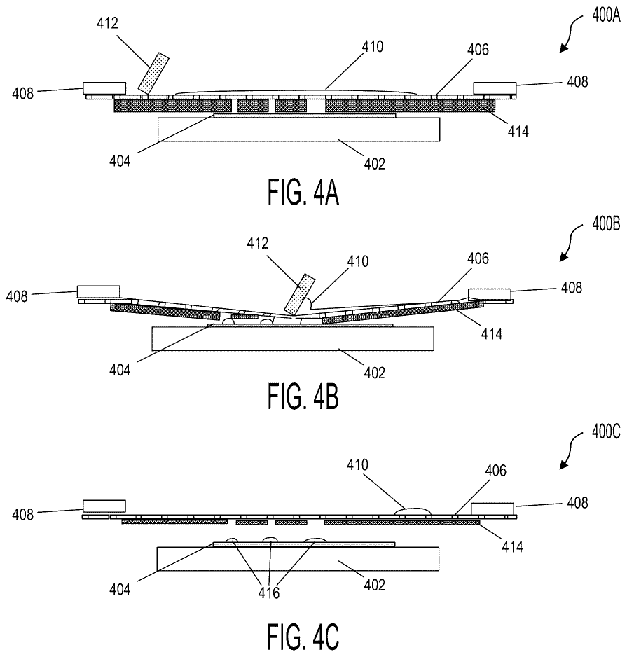

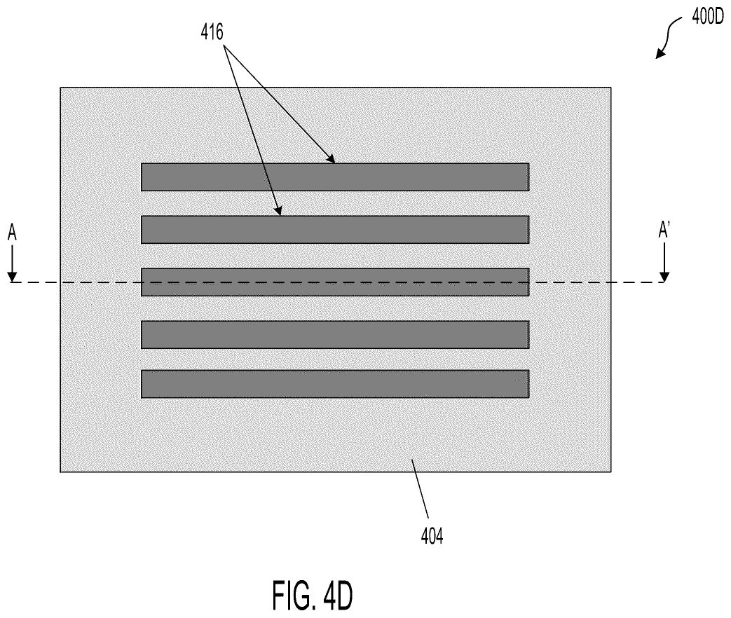

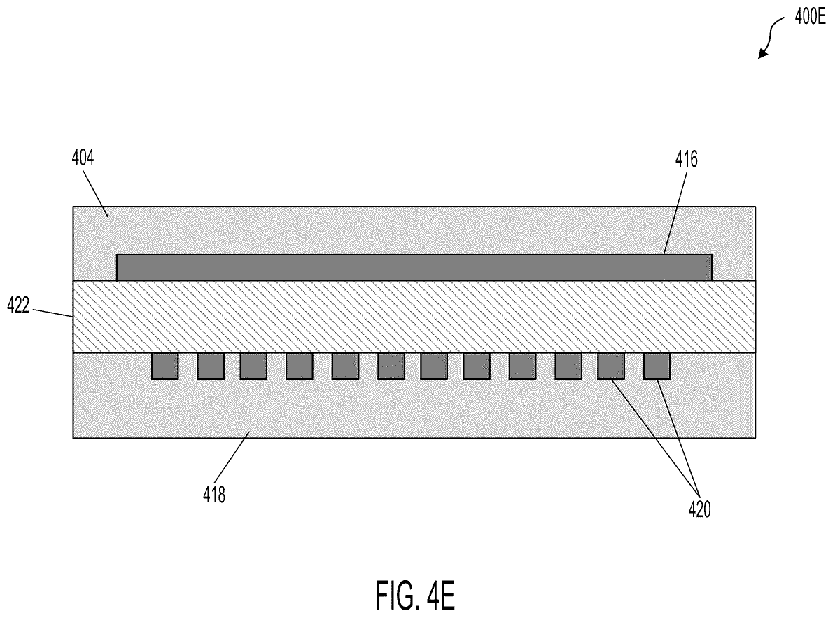

The first conductive regions can be arranged to conform to locations on the first substate material where tactile sensing is to occur. In some implementations, the first conductive regions may include traces that are to couple with one or more external circuits or connectors, such that electrical signals can be transmitted to circuitry that can detect force, touch, or pressure events based on changes in electrical properties at the sensing regions (e.g., other portions of the conductive regions). In some implementations, the set of first conductive regions can be defined by depositing a conductive ink onto the surface of the first substrate using a screen-printing process. The conductive ink may be deposited using other types of printing processes, such as 3D printing/deposition techniques. An example process for defining the conductive regions using a screen-printing process is shown in FIGS. 4A, 4B, 4C, and 4D.

Referring to FIGS. 4A, 4B, 4C, and 4D, illustrated are diagrams 400A, 400B, 400C, and 400D showing an example 3D screen printing process for defining conductive ink on substrate material used to create the 3D tactile sensors described herein, in accordance with one or more implementations. In FIG. 4A, the diagram 400A is shown as including a screen-printing system having a printing chuck 402, a screen mesh 406, screen frames 408, at least one conductive ink 410, a blade, and a stencil film 414. The screen-printing process can be used to define one or more regions of conductive ink 410 on a substrate material 404.

To perform screen-printing, a layer of substrate material 404 for the 3D tactile sensor can be positioned on a printing chuck 402 within the screen-printing system. As described herein, the substrate material 404 may include a polymer such as TPU, PET, or polyimide, among others. The substrate material 404 can be provided in a planar sheet, which may be cut or etched to a predetermined size or shape. The layer of substrate material 404 can be arranged such that the upper surface of the substrate material 404 faces the screen mesh 406. The stencil film 414 can be positioned between the screen mesh 406 and the layer of substrate material 404. The stencil film 414 can include a pattern of openings corresponding to the desired arrangement of conductive regions on the substrate material 404. The stencil film 414 can include openings or apertures that define the geometry, location, or dimensions of the conductive traces and sensing elements to be formed on the substrate material 404.

The screen-printing process can involve the deposition of one or more types of conductive ink 410. The conductive ink 410 may be any type of ink that can conduct electricity (e.g., with a target amount of conductivity). non-limiting examples of the conductive ink 410 include silver nanoparticle ink, silver-flake-based ink, carbon-based ink, or copper-based ink, among others. In some implementations, the conductive ink 410 can be formulated to provide a target viscosity, particle size distribution, or electrical conductivity suitable for screen printing on the substrate material 404. Initially, the conductive ink 410 can be dispensed onto the upper surface of the screen mesh 406, such that the ink can be transferred through the patterned openings of the stencil film 414 using the blade 412. The blade 412 can be used to spread the conductive ink 410 across the screen mesh 406, such that the conductive ink 410 is forced through the stencil film 414 and deposited onto the substrate material 404 in a pattern defined by the stencil film 414.

FIG. 4B shows the next stage of the screen-printing process, in which the blade 412 is used to force the conductive ink 410 through the patterned openings of the stencil film 414. In some implementations, the blade 412 can be moved across the screen mesh 406 at a predetermined angle relative to the substrate material 404, such that the conductive ink 410 is forced through the stencil pattern in a uniform manner. The blade 412 can be moved across the screen mesh 406 while maintaining a constant downward pressure, such that the conductive ink 410 is deposited onto the substrate material 404 in accordance with the geometry defined by the stencil film 414. In some implementations, the blade 412 can be oscillated or moved in a non-linear motion to facilitate the transfer of the conductive ink 410 through the openings of the screen mesh 406 and the stencil film 414. The blade 412 may be moved using an actuator, manual force, or a combination thereof.

In FIG. 4C, diagram 400C shows the arrangement of components of FIGS. 4A and 4B following the screen-printing process for defining conductive regions 416 on the surface of the substrate material 404. As shown, after the conductive ink 410 has been forced through the screen mesh 406, the screen frame 408 can be lifted above and removed from the surface of the print chuck 402. The resulting conductive regions 416 can form traces and sensing elements on the upper surface of the substrate material 404, such that the substrate material 404 can be used in subsequent assembly steps for the fabrication of a 3D tactile sensor. Any number or pattern of conductive regions 416 can be defined on the surface of the substrate material 404. In some implementations, the conductive regions may define connection regions for one or more connectors that are to be coupled to the substrate material 404. An example top view of the substrate material 404 is shown in FIG. 4D.

In FIG. 4D, the diagram 400D shows a top view of the substrate material 404 with the conductive regions 416 disposed thereon. In this example, the conductive regions 416 are arranged as a set of elongated traces extending in parallel across the surface of the substrate material 404. The conductive regions 416 can be positioned to correspond to sensing locations for a three-dimensional tactile sensor, such that each conductive region 416 can function as an electrode or sensing element. In some implementations, the arrangement of the conductive regions 416 can be determined according to a target spatial resolution or sensing geometry for the 3D tactile sensor. Conductive regions 416 corresponding to different sensing elements or traces can be electrically isolated from one another on the surface of the substrate material 404, such that each conductive region 416 can be monitored by external circuitry. Although parallel conductive regions 416 are shown in FIG. 4D, it should be understood that any number, arrangement, or pattern of conductive regions 416 may be provided on the surface of the substrate material 404.

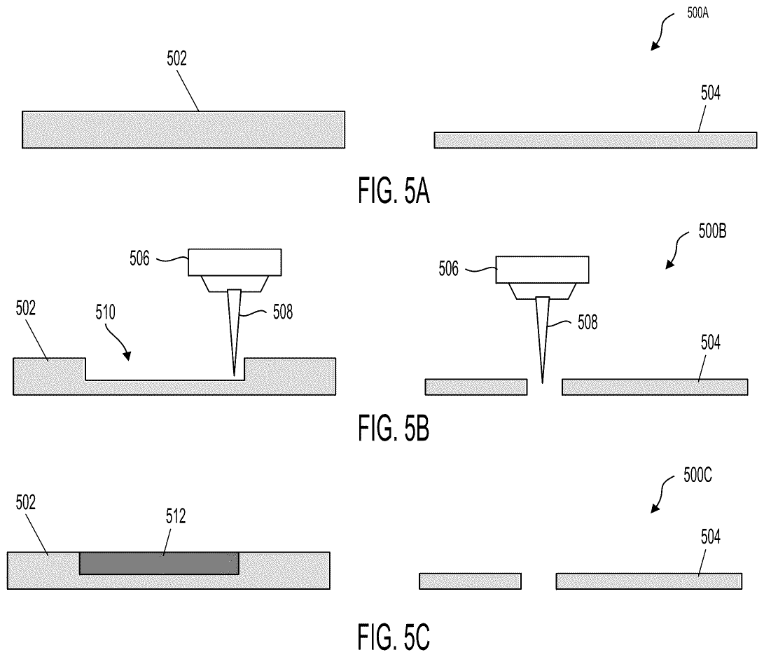

Referring back to STEP 310 of the method 300 of FIG. 3, in some implementations, the set of first conductive regions can be defined by etching or cutting one or more channels into the first substrate using a laser beam or a mechanical cutting process. A conductive paste can be deposited into the channels using a suitable dispensing process. The conductive paste, which may be a silver-derived paste, can be cured or dried to form the conductive regions on the substrate material. In some implementations, channels defined in the substrate material may correspond to a desired pattern of traces or sensor regions. In some implementations, one or more portions of the substrate material may be treated to facilitate binding with the conductive paste. Connectors or exposed pads may be coupled to or formed as part of the conductive regions, to facilitate coupling to one or more external sensing circuits. An example process for defining the conductive regions using conductive paste is shown in FIGS. 5A, 5B, 5C, 5D, and 5E.

Referring to FIGS. 5A, 5B, 5C, 5D, and 5E, illustrated are diagrams 500A, 500B, 500C, 500D, and 500E showing an example process to manufacture one or more layers of a 3D tactile sensor. In FIG. 5A, the diagram 500A shows a layer of substrate material 502 and a corresponding cover layer 504. As described herein, the substrate material 502 can include a polymer such as TPU, PET, or polyimide, among others. The substrate material 502 can be provided in a sheet or layer form and can be cut to a target shape or dimensions of the 3D tactile sensor. In some implementations, the cover layer 504 can include the same material as the substrate material 502 or can include a different compliant material (e.g., a polymer, etc.). The cover layer 504 can be cut or formed to match the dimensions or geometry of the substrate material 502, such that the cover layer 504 can be laminated or otherwise coupled to the substrate material 502 in subsequent process steps.

In FIG. 5B, the diagram 500B shows the formation of channels 510 in the substrate material 502. In some implementations, the laser device 506 can include, but is not limited to, a carbon dioxide laser, a fiber laser, or a diode-pumped solid-state laser. The laser device 506 can provide a focused laser beam 508 controlled to etch channels 510 in the substrate material 502 according to a pattern of traces for the 3D tactile sensor. The laser beam 508 can be directed according to a predetermined path specified via control instructions. The path may indicate coordinates and depth information for etching the one or more channels 510 in the substrate material 502. In some implementations, the laser device 506 can automatically adjust the power, pulse duration, and/or scanning speed based on the thickness or type of the substrate material 502. For example, certain substrate materials 502 may require additional cutting time or energy to form the channels 510 compared to other substrate materials 502. A channel 510 may also be formed by cutting an opening through a sheet of substrate material 502 with the laser beam, then laminating that sheet of substrate material 502 onto a solid sheet of the same substrate material 502.

In some implementations, other etching or cutting techniques can be used to form channels 510 in the substrate material 502. For example, a chemical etching process can be performed by applying a patterned mask to the substrate material 502 and exposing selected regions to a chemical etchant. In some implementations, mechanical cutting processes may be performed using a blade or a rotary tool to define the channels 510. For example, a computer numerical control (CNC) cutting machine, with a suitable number of degrees of freedom, may be used to mechanically cut one or more of the channels 510 in the substrate material 502. The cover layer 504 can be etched or cut using similar approaches to provide one or more openings that are to expose one or more portions of the conductive regions formed in subsequent process steps. In this example, an opening in the cover layer 504 is shown as being cut using a laser device 506 with a corresponding laser beam 508. The openings can correspond to electrical contact regions for the 3D tactile sensor.

In FIG. 5C, the diagram 500C shows the deposition of conductive paste 512 (sometimes referred to as “conductive material 512”) in the channel 510 defined in the substrate material 502. In some implementations, the substrate material 502 can undergo a surface treatment process following the creation of the channels 510 and prior to the deposition of the conductive paste 512. The surface treatment can include plasma treatment, corona discharge, or chemical priming, among others, such that substrate material 502 is modified to improve adhesion prior to deposition of the conductive paste 512. In some implementations, the substrate material 502 can be heated or exposed to ultraviolet light to further modify the surface energy of the channel 510. The type of surface treatment used, if any, can depend on the type of substrate material 502 used to create the 3D tactile sensor.

The conductive paste 512 can include any type of conductive material that can be spread or otherwise provided within the channel 510. Non-limiting examples of conductive paste 512 can include a Gallium-Indium alloy, a silver nanoparticle dispersion, a carbon-based paste, or a copper-based paste, among others. The conductive paste 512 can be deposited into and spread through the channel 510 using a nozzle dispensing system, a jetting system, or a blade/squeegee. For example, the nozzle dispensing system can provide a controlled volume of the conductive paste 512 into the channel 510 according to a predetermined path. A nozzle dispensing system may include a 3D printer or similar device that can dispense material at specified locations. In another example, a jetting system can deposit droplets of the conductive paste 512 in a pattern that conforms to the geometry of the channel 510. Similarly, a squeegee can be used to force the conductive paste 512 into the channel 510 by applying pressure along the length of the channel 510, using techniques similar to those described in connection with FIG. 4B. The conductive paste 512 can then dry or be cured using a suitable curing process to define conductive regions on the surface of the substrate material 502.

In FIG. 5D, the diagram 500D shows the cover layer 504 being aligned over the surface of the substrate material 502. In some implementations, the cover layer 504 can be laminated onto the substrate material 502 using a process such as adhesive bonding or pressure lamination. The cover layer 504 can be positioned such that the one or more openings etched/cut through the cover layer 504 are aligned portions of the conductive material 512 disposed within the substrate material 502 that are to be exposed. The lamination process can be performed under controlled temperature and pressure conditions to provide that the cover layer 504 adheres to the substrate material 502 without displacing the conductive material 512. The cover layer 504 may be aligned with the top surface of the substrate material 502 using one or more mounting brackets or jigs.

In some implementations, additional conductive material 512 can be dispensed into the opening of the cover layer 504 prior to or following the lamination process. The additional conductive material 512 can be deposited to fill the exposed region and provide electrical continuity between the underlying conductive channel and any external components that may be coupled to the cover layer 504 in subsequent process steps. The deposition of the additional conductive material 512 can be performed using any dispensing process described herein. In some implementations, the surface of the additional conductive material 512 may be treated following curing to facilitate bonding to other components in subsequent process steps.

In FIG. 5E, the diagram 500E shows a flexible PCB being coupled to the surface of the cover layer 504 in contact with the exposed portion of the conductive paste 512. The flexible PCB 514 may include exposed traces or pads that are aligned with the exposed portion of the conductive material 512. The exposed traces or pads can be in electrical contact with the conductive material 512. The flexible PCB 514 can be positioned over the cover layer 504 and can be coupled to the cover layer 504 using an adhesive, a lamination process, or a mechanical fastener, among others. In some implementations, an additional substrate layer 516 can be provided above the flexible PCB 514 to encapsulate or protect at least a portion of the flexible PCB 514 and the substrate material 502, as shown.

In some implementations, the exposed traces on the flexible PCB 514 can be aligned with the exposed portion of the conductive material 512 based on the geometry of the openings in the cover layer 504 and the layout of the conductive material 512 within the substrate material 502. The alignment can be performed using an optical registration system or mechanical alignment brackets/jigs. The flexible PCB 514 can be electrically coupled to external circuitry can monitor or detect changes in the conductivity or capacitance of the conductive material 512 within the 3D tactile sensor. In some implementations, the flexible PCB 514 may include one or more connectors that can couple to electric wires or cables connected to additional control circuitry for the 3D tactile sensor.

Referring back to FIG. 3, the method 300, at STEP 315, can include coupling a separator layer between the first substrate and a second substrate having a second set of conductive regions. In some implementations, STEPS 305 and 310 of the method 300 can be repeated to define conductive regions on two layers of substrate material. The second substrate can be similar to the first substrate and may be formed according to any of the techniques described herein. In some implementations, the first and second layers of substrate (with corresponding conductive regions) may be formed using different techniques (e.g., screen-printing, conductive paste deposition, etc.). The first substrate and the second substrate can be aligned such that the conductive regions on each substrate layer are positioned to form sensing elements when separated by the separator layer. The sensing elements (e.g., pixels) can be portions of the conductive regions of the substrate layers that overlap one another.

In some implementations, the separator layer can include a dielectric material when the tactile sensor is to operate in a capacitive sensing mode. The dielectric material can be any type of compliant dielectric that provides electrical insulation between the conductive regions of the substrate layers. In implementations where the 3D tactile sensor is a resistive sensor, the separator layer can include a piezoresistive material. The piezoresistive material can include, but is not limited to, compliant materials such as carbon-loaded silicone, conductive elastomers, or conductive foams. The resistance of the piezoresistive material can vary in response to applied force. The separator layer can be coupled between the first substrate and the second substrate by adhesive bonding, lamination, or thermal bonding, or any other bonding technique, to form a layer stack. An example representation of such a layer stack is described in connection with FIG. 4E.

Referring to FIG. 4E, illustrated is a cross-sectional view 400E of a 3D tactile sensor, from the perspective of the line segment AA′ shown in FIG. 4D. In this example, the top substrate material 404 can be the substrate constructed according to the techniques described in connection with FIGS. 4A-4E. The conductive regions 416 can be disposed on a surface of the substrate material 404 and can define sensing electrodes and/or traces for the 3D tactile sensor. The separator material 422 is shown as being positioned between the substrate material 404 and a bottom substrate material 418. The separator material 422 can include a dielectric material or a piezoresistive material, as described herein. The thickness of the separator material 422 (e.g., distance between the top substrate material 404 and bottom substrate material 418) can be selected to achieve a target baseline capacitance or baseline resistance in the 3D tactile sensor.

The bottom substrate material 418 can be constructed using techniques similar to those used to construct the top substrate material 404. The bottom substrate material 418 is shown as including one or more bottom conductive regions 420 that can be arranged to correspond to the conductive regions 416 on the substrate material 404. Although the top conductive regions 416 and the bottom conductive regions 420 are shown as being in contact with the separator material 422, in some implementations, the top conductive regions 416 and the bottom conductive regions 420 can be defined within the top and bottom substrate materials 404 and 418, respectively, and not necessarily in contact with the separator material 422. In some implementations, the separator material 422 can electrically isolate the conductive regions 416 from the bottom conductive regions 420. The stack formed by the substrate material 404, the conductive regions 416, the separator material 422, the bottom substrate material 418, and the bottom conductive regions 420 can be formed to conform to a target 3D geometry, as described in further detail herein.

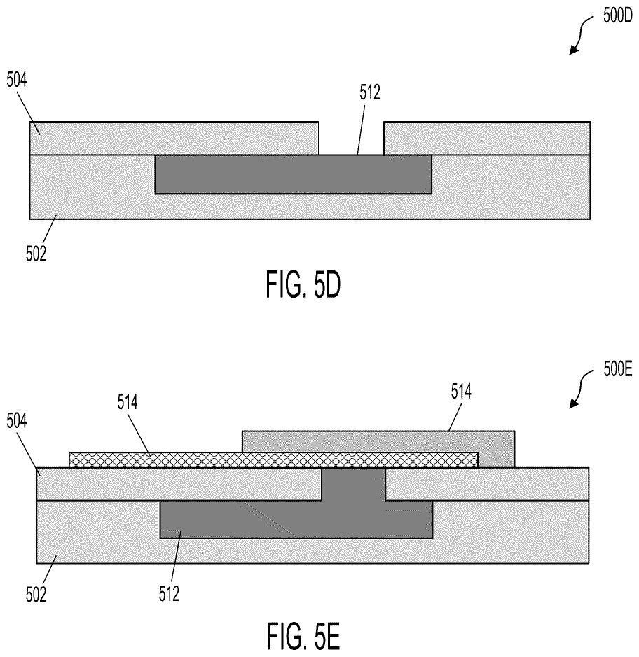

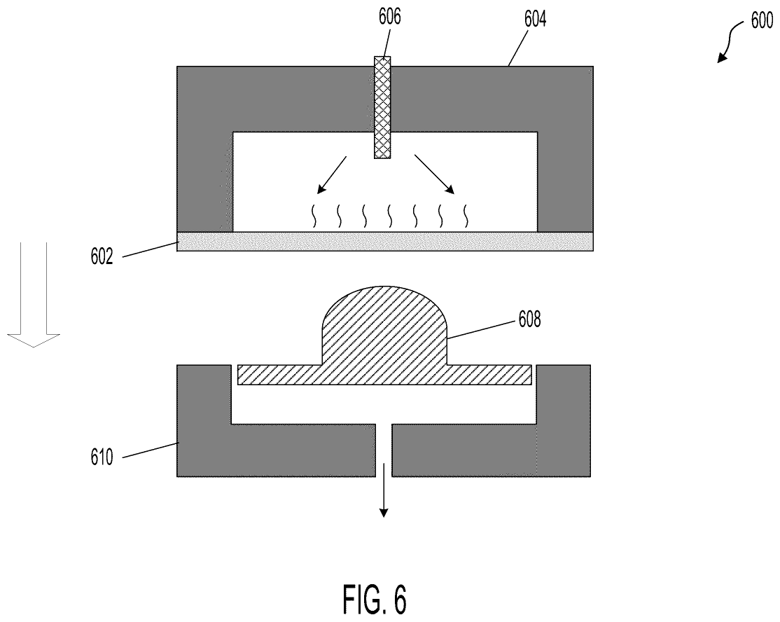

Referring back to FIG. 3, the method 300, at STEP 320, can include forming the stack of the first substrate, the second substrate, and the separator layer can be formed into a target structure. In one example, the stack can be formed to a target 3D geometry by applying a thermoforming process, in which the stack can be heated to a temperature above the glass transition temperature of the substrate materials and pressed into a mold that defines the target 3D shape. In another example, the stack can be formed by compression molding, in which the stack can be placed between two mold surfaces and subjected to pressure and heat such that the stack conforms to the contours of the mold. In yet another example, the stack can be formed by vacuum forming, in which the stack can be heated and drawn against a mold surface by application of vacuum pressure such that the stack conforms to the mold geometry. An example representation of a thermoforming process is shown in FIG. 6. The 3D tactile sensor resulting from the example thermoforming process is shown in FIG. 7.

Referring to FIG. 6, illustrated is a diagram of a thermoforming system 600 for shaping a 3D compliant tactile sensor. The thermoforming system 600 can include a heater housing 604, a heat source 606, a sensor mold 608, or a mold base 610. As shown, a layer stack 602 (for example, the material stack shown in FIG. 4E) can be coupled to the heater housing 604 and can be subjected to heat generated by the heat source 606. The sensor mold 608 is positioned within the mold base 610 such that the sensor mold 608 defines a surface contour corresponding to the target 3D geometry for the layer stack 602. The mold base 610 can be coupled to the sensor mold 608 such that the sensor mold 608 is fixed in place. As shown, openings may be provided in one or more portions of the sensor mold 608 or the mold base 610 to facilitate the thermoforming process.

To thermoform the layer stack 602, heat from the heat source 606 can be applied and to the layer stack 602. In some implementations, the heat source 606 may provide positive air pressure at the top side of the layer stack 602 to facilitate the thermoforming process. The heater housing 604 can be lowered, or the mold base can be raised, to press the heated layer stack 602 against the sensor mold 608. The layer stack 602 can be heated to a glass transition temperature, such that the layer stack 602 conforms to the geometry of the sensor mold 608. The heat source 606 can be deactivated and the layer stack 602 can be allowed to cool on the sensor mold 608. The formed layer stack 602 can then be removed from the sensor mold 608. Once cooled below a threshold temperature, the resulting formed layer stack 602 can retain the 3D shape defined by the sensor mold 608, which corresponds to the target 3D structure for the 3D tactile sensor. A 3D tactile sensor formed using the techniques described herein is shown in FIG. 7.

Referring to FIG. 7, illustrated is a cross-sectional view of an example 3D tactile sensor 700. The 3D tactile sensor 700 can be a formed layer stack similar to the stack of layers shown in FIG. 4E, following a thermoforming process. The 3D tactile sensor 700 includes a lower substrate material 702, lower conductive regions 704, an upper substrate material 706, upper conductive regions 708, and a separator material 710. In this example, 3D tactile sensor 700 has been formed into a curved structure. Following thermoforming, the arrangement of the lower conductive regions 704 and the upper conductive regions 708 defined in the lower substrate material 702 and the upper substrate material 706 are maintained across from one another, separated by the separator material 710. This enables the 3D tactile sensor to operate after forming to a target 3D geometry.

In some implementations, the 3D tactile sensor 700 can be cut or etched to a target shape following the thermoforming process. For example, the 3D tactile sensor 700 can be trimmed using a mechanical cutting tool, a die-cutting apparatus, or a laser cutting system to define an outer profile that conforms to a target geometry. The 3D tactile sensor 700 can be mounted on a backing material (e.g., the backing material 204 of FIG. 2) following the cutting or etching operation. The mounting process can include adhesive bonding, overmolding, or mechanical fastening to secure the 3D tactile sensor to a hard or soft backing, as described in connection with FIG. 2. In some implementations, one or more layers of protective material (e.g., the protective layer 206) can be provided over the 3D tactile sensor 700.

Referring to FIG. 8, illustrated is a method 800 for manufacturing a 3D tactile sensor. The method 800 may be performed to create a 3D tactile sensor on a substrate that is pre-formed to a target 3D geometry. Various approaches may be used to define conductive regions on the surface of the formed substrate. The method 800 may be performed to create any of the 3D tactile sensors described herein, including but not limited to the 3D tactile sensors 102A, 102B, and 102C of FIG. 1 and the 3D tactile sensor 202 of FIG. 2. In brief overview of the method 800, the method 800 can include forming a first substrate according to a target structure for a sensor (STEP 805), defining first conductive regions for the sensor on the first substrate (STEP 810), providing a separator material over at least a portion of the first conductive regions (STEP 815), and coupling a second substrate having second conductive regions to the separator material (STEP 820).

The method 800, at STEP 805, can include forming a first substrate according to a target structure for a sensor. The first substrate can be selected using approaches similar to those described for STEP 305 of the method 300 of FIG. 3, in which a flexible or formable substrate material can be provided in a sheet or film form. In one example, the first substrate can be formed to a target 3D structure for the 3D tactile sensor by subjecting the substrate material to a thermoforming process. The thermoforming process can include heating the substrate material to a temperature above the glass transition temperature and pressing the substrate material into a mold that defines the target 3D geometry. The substrate material can be cooled such that the substrate retains the formed shape. In some implementations, the first substrate can be formed to the target 3D structure by using a molding process such as injection molding or compression molding. In another example implementation, the first substrate can be formed by casting a liquid precursor of the substrate material into a mold and curing the material to achieve the desired geometry. Mechanical formation techniques may also be used to form the substrate material. For example, the first substrate can be formed by machining or cutting a bulk material to the target 3D shape.

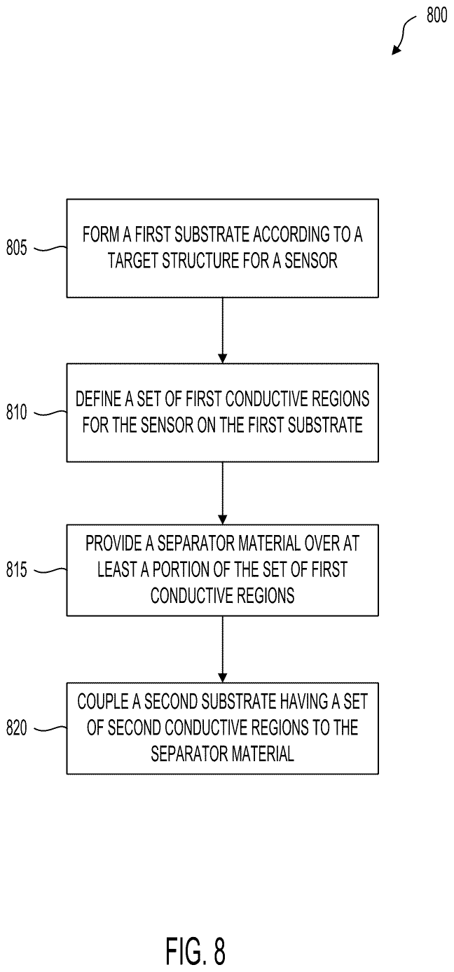

The method 800, at STEP 810, can include defining the set of first conductive regions for the sensor on the first substrate. As described herein, the first conductive regions can include patterned traces or electrodes that can function as sensing elements for the 3D tactile sensor. The first conductive regions can be used to detect changes in electrical properties (e.g., resistance or capacitance) of the 3D tactile sensor in response to contact, force, or pressure applied to the 3D tactile sensor. In some implementations, the set of first conductive regions can be defined on the first substrate using any of the techniques described in connection with STEP 310 of the method 300 of FIG. 3. In one example, the first conductive regions can be defined by depositing a conductive material onto the surface of the formed substrate using a 3D dispensing technique. The 3D dispensing technique can include dispensing a conductive ink or paste along a predetermined pattern on a curved surface of the substrate. An example diagram showing a 3D dispensing for forming conductive regions is shown in FIG. 9.

Referring to FIG. 9, illustrated is a diagram 900 showing a 3D dispensing process for forming conductive traces on a formed substrate material, in accordance with one or more implementations. The diagram 900 shows a dispensing head 906 forming a set of conductive regions 904 on formed substrate material 902. The dispensing head 906 can include any type of dispensing device. For example, the dispensing head 906 may include a nozzle-based dispenser or a syringe pump. In some implementations, the dispensing head 906 may be part of a CNC system or gantry system (e.g., a 3D printer) that can operate according to control signals specifying a dispensing path and dispensing rate. The conductive regions 904 can be formed using a conductive ink or paste, such as a silver nanoparticle ink, a silver-flake-based ink, a carbon-based ink, or a Gallium-Indium alloy paste, among others.

The conductive ink or paste can be dispensed in a liquid or semi-liquid state and can undergo a curing or sintering process after deposition on the formed substrate material 902. In some implementations, the dispensing head 906 can move relative to the formed substrate material 902 based on a predetermined pattern, such that the conductive regions 904 are deposited in a specified arrangement on the surface of the formed substrate material 902. In some implementations, the predetermined pattern can correspond to a grid, an array, or any suitable electrode layout for a tactile sensor array. The dispensing process can be repeated for multiple regions of the formed substrate material 902 to create multiple isolated conductive regions 904 corresponding to different traces or sensing elements.

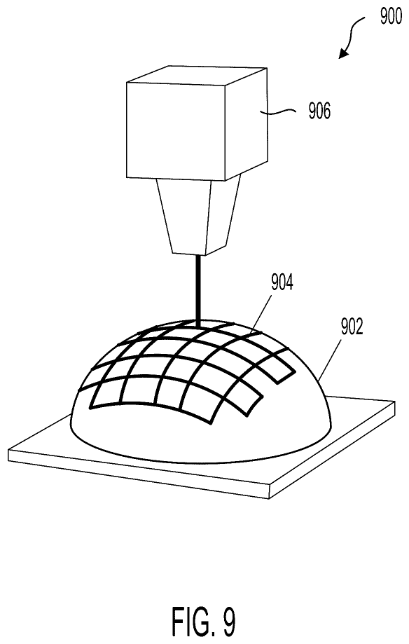

Referring back to STEP 810 of the method 800 of FIG. 8, in another example, the first conductive regions can be defined by activating selected regions of the substrate using a laser in a laser-direct structuring process. The laser-direct structuring process can include scanning a laser beam over the substrate to activate portions of the substrate material, followed by plating the activated regions with a conductive metal such as copper, nickel, or gold, among others. To activate portions of the substrate material, a laser can direct a laser beam along a predetermined pattern such that the substrate material is selectively activated in regions corresponding to the target conductive regions. The activated substrate can be immersed in a plating bath including a metal salt solution. An example laser-direct structuring process for forming conductive regions is shown in FIGS. 10A and 10B.

Referring to FIGS. 10A and 10B, illustrated are diagrams 1000A and 1000B showing a laser-direct structuring process for forming conductive regions on formed substrate material 1002. In FIG. 10A, the diagram 1000A shows a laser 1006 forming one or more activated regions 1004 on a formed substrate material 1002. The formed substrate material 1002 may include one or more additives to facilitate laser-direct structuring. For example, the substrate material 1002 may include one or more metal-organic compounds. In some implementations, surface treatment can be applied to the formed substrate material 1002 prior to laser activation. The laser 1006 can include any type of laser that can activate the additives in the substrate material 1002. The laser 1006 can generate a laser beam 1008 having a predetermined wavelength that can be directed onto the formed substrate material 1002 to activate regions for subsequent plating. The laser beam 1008 can be scanned across the surface of the formed substrate material 1002 according to a predetermined pattern, such that the activated regions 1004 correspond to a layout of conductive traces or electrodes for a three-dimensional tactile sensor.

In FIG. 10B, the diagram 1000B shows the substrate material 1002 following a plating process, in which the activated regions 1004 are plated with metal to form the conductive regions 1010. In one example, the plating process can include immersing the activated substrate material 1002 in a metal plating bath (e.g., a copper, nickel, or gold salt solution, etc.). When the activated regions 1004 are exposed to the plating bath, metal ions are selectively deposited on the activated regions 1004. In another example, the plating process can include electroplating, where an electrical potential can be applied between the activated substrate material 1002 and a counter electrode, such that metal ions from the plating bath can deposit on the activated regions 1004. In some implementations, a combination of chemical plating and electroplating can be used, where an initial metal layer can be deposited chemically on the activated regions 1004, followed by thickening of the metal layer using electroplating. The resulting conductive regions 1010 can correspond to the pattern of the activated regions 1004 on the surface of the activated substrate material 1002.

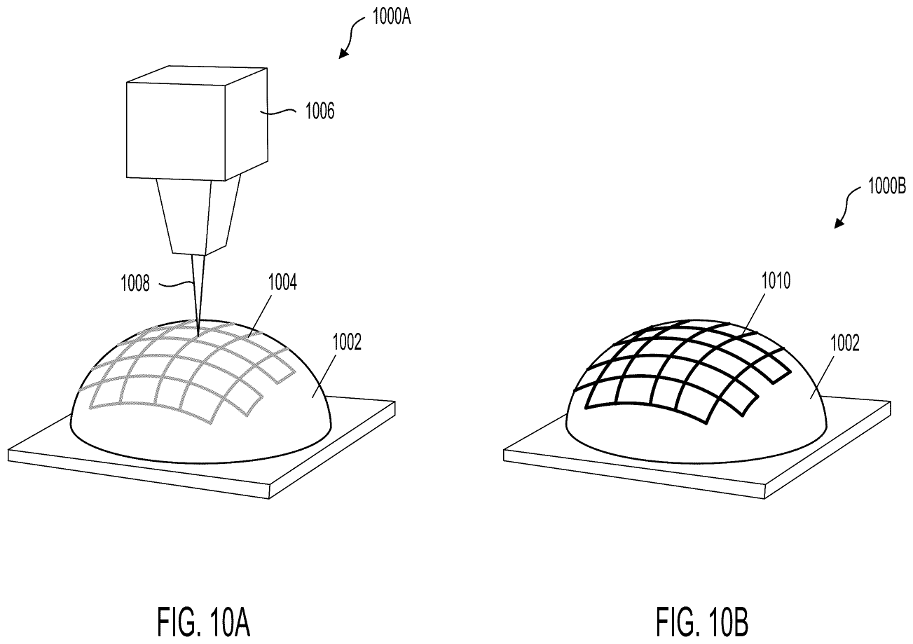

Referring back to STEP 810 of the method 800 of FIG. 8, in some implementations, the first conductive regions can be defined by transferring a conductive ink or paste onto the formed substrate material using a pad printing process. The pad printing process can include transferring a patterned layer of conductive ink from an etched printing plate to the 3D surface of the substrate material using a silicone pad that can conform to the geometry of the substrate. The pad printing process can be used to apply conductive patterns to curved, concave, or irregular surfaces of the formed substrate material. The conductive ink used in the pad printing process can include silver nanoparticle ink, silver-flake-based ink, or carbon-based ink, among others. In some implementations, the pad printing process can be repeated to deposit multiple layers of conductive ink or to form different electrode patterns on the three-dimensional surface of the substrate material. An example pad printing process for forming conductive regions is shown in FIGS. 11A and 11B.

Referring to FIGS. 11A and 11B, illustrated are diagrams 1100A and 1100B showing the definition of conductive regions on a formed substrate material 1106 using a pad printing process. In FIG. 11A, the diagram 1100A shows a pad printer 1102 having a print head 1104 that can be used to apply the conductive ink 1108 on the surface of the formed substrate material 1106. In some implementations, the conductive ink 1108 can include silver nanoparticles, silver-flake-based ink, or carbon-based ink, as described herein. In some implementations, the pad printer 1102 patterned conductive ink can be applied to the printer head 1104 via from an etched printing plate. The print head 1104 can transfer the conductive ink 1108 onto the formed substrate material 1106 such that the conductive regions conform to the 3D geometry of the substrate.

In FIG. 11B, the diagram 1100B shows the formed substrate material 1106 following the transfer of the conductive ink 1108. As shown, the conductive ink 1108 can conform to the three-dimensional geometry of the formed substrate material 1106. In some implementations, the transfer of the conductive ink 1108 can be followed by a curing process to cause the conductive ink 1108 to adhere to the surface of the formed substrate material 1106. The resulting structure can include conductive regions forming traces or sensing elements on the curved or irregular surface of the formed substrate material 1106. Additional layers can be coupled to the surface of the substrate material 1106 to form a 3D tactile sensor as described in further detail herein.

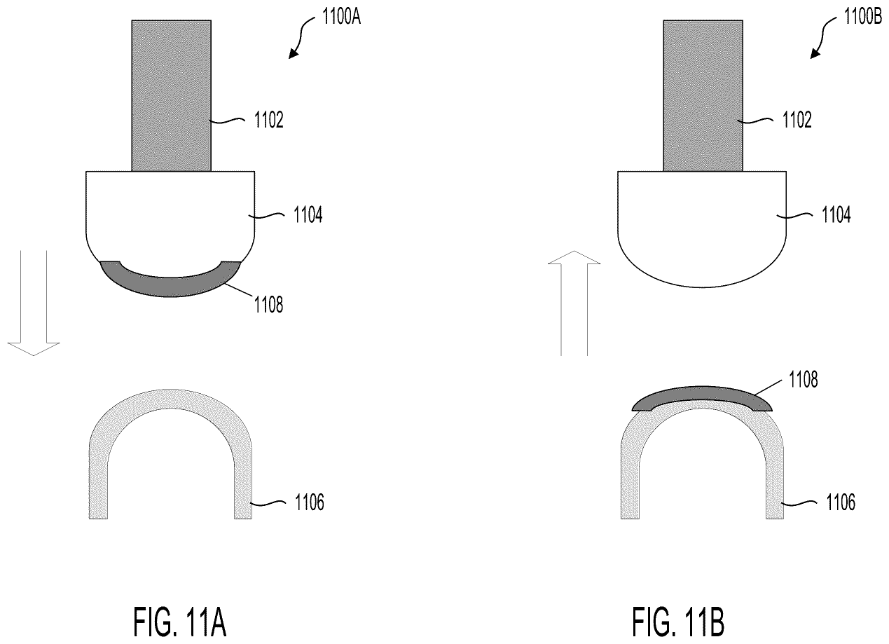

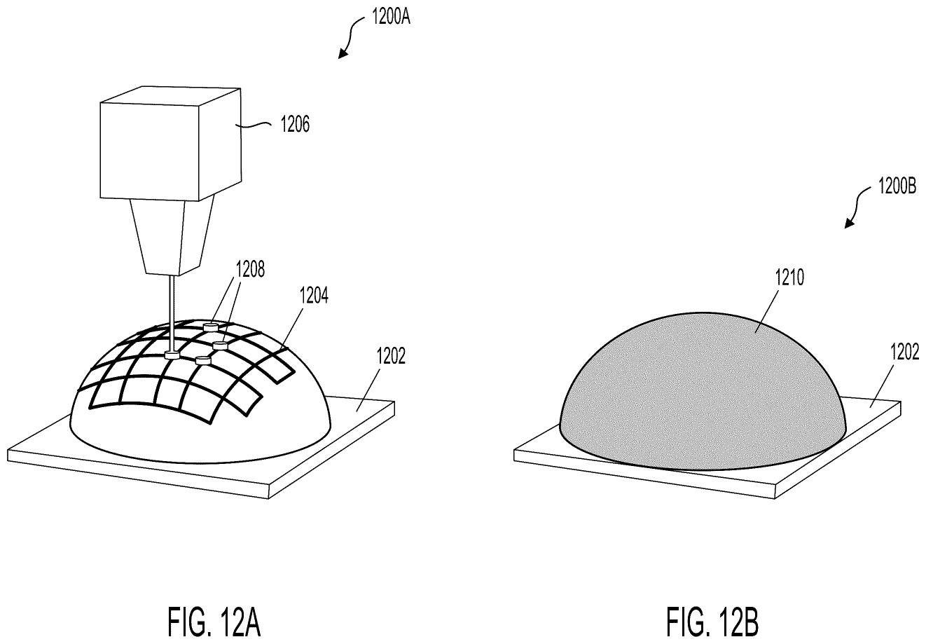

Referring back to FIG. 8, the method 800, at STEP 815, can include providing a separator material over at least a portion of the first conductive regions. The separator material can include a dielectric material for a capacitive sensor or can include a piezoresistive material when for a resistive sensor. In one example, the separator material can be defined using a 3D dispensing process. In some implementations, the separator material can be deposited as a continuous layer across the substrate material, for example, using a thermoforming process or similar molding technique. The thickness and coverage of the separator material can be controlled according to the target electrical characteristics of the 3D tactile sensor. An example process for forming separator material using a 3D dispensing technique is shown in FIG. 12A.

FIG. 12A shows a diagram 1200A of a 3D dispensing process for forming separator material on conductive regions of a substrate material. In the diagram 1200A, a dispensing head 1206 is shown depositing regions of separator material 1208 on the surface of the substrate material 1202 and the conductive regions 1204. In some implementations, the dispensing head 1206 can include a nozzle-based dispenser, a syringe pump, or any other type of printing system. The dispensing head 1206 can be coupled to and positioned by a CNC system, a robotic arm, or a gantry-based positioning system. The dispensing head 1206 may receive control signals specifying a dispensing rate or a dispensing pressure to deposit the separator material 1208 in predetermined amounts. Different dispensing parameters may be used for different types of separator material 1208.

The regions of separator material 1208 can be positioned in predetermined locations on the surface of the substrate material 1202, and on at least a portion of the conductive regions 1204, to define sensing elements. In some implementations, the dispensing head may be fixed in place, and the substrate material 1202 may be coupled to a gantry or other positioning system to move the substrate material 1202 to predetermined locations beneath the dispensing head 1206. In this example, the separator material 1208 is shown as being deposited in various spots on the surface of the conductive regions. As described in further detail herein, electrodes can be defined by coupling a second substrate having other conductive regions on the opposite side of the separator material 1208. The separator material 1208 may include a dielectric material for capacitive sensors or may include a piezoresistive material for resistive sensors. Any suitable pattern or amount of separator material 1208 may be deposited on the surface of the conductive regions 1204 and the substrate material 1202.

In some implementations, the separator material 1208 can include an adhesive material such that the separator material 1208 can bond to the substrate material 1202. For example, the separator material 1208 can be provided as a pressure-sensitive adhesive or a thermally activated adhesive. In some implementations, the separator material 1208 can be deposited as a film. In some implementations, an adhesive material may be first deposited on the substrate material 1202, followed by depositing or coupling the separator material 1208 to the substrate material 1202 via the adhesive material. In another example, the separator material 1208 (e.g., in layer or sheet form) can be laminated onto the substrate material 1202. Combinations of approaches for coupling separator material 1208 may also be used.

Referring back to FIG. 8, the method 800, at STEP 820, can include coupling a second substrate having second conductive regions to the separator material. In some implementations, the second substrate can be positioned such that the separator material is disposed between and coupled to the first substrate and the second substrate. The separator material can electrically isolate the first conductive regions defined on the first substrate from the second conductive regions defined on the second substrate. The second conductive regions can be arranged to correspond to and overlap the first conductive regions, where the overlapping conductive regions (separated by the separator material) can form sensing elements. The sensing elements can be capacitive or resistive sensor structures, as described herein. In some implementations, the separator material can be or include an adhesive material, such as a pressure-sensitive adhesive or a thermally activated adhesive, which can bond the first substrate and the second substrate while maintaining electrical isolation between the conductive regions of the first substrate and the second substrate.

The second substrate may be manufactured using techniques similar to those described in connection with STEPS 305 and 310 of the method 300 of FIG. 3. For example, the second substrate can be provided as a flexible film of TPU, PET, or polyimide, with second conductive regions can be defined on the second substrate using a screen-printing process or a process involving the deposition of conductive ink in channels (e.g., described in connection with FIGS. 5A-5E). In some implementations, the second substrate can be formed to a target 3D structure prior to coupling to the separator material, for example, by thermoforming or compression molding. For example, techniques similar to those described in connection with STEPS 805 and 810 (e.g., a laser-direct structuring process, a pad printing process, etc.) may be used to form the second substrate material and define the second conductive regions thereon. To couple the second substrate to the separator material, the second substrate can be aligned with and adhered at least one of the separator material or the first substrate material using a suitable adhesive or bonding technique. An example showing a 3D tactile sensor formed according to such techniques is shown in FIG. 12B.

Referring to FIG. 12B, illustrated is a diagram 1200B of a 3D tactile sensor formed by fixing a layer of second substrate material 1210 on the surface of the substrate material 1202. The layer of the second substrate material 1210 can be deposited subsequent to the deposition of the separator material as shown in FIG. 12A. As described herein, the second substrate material 1210 can include conductive regions that correspond to the conductive regions 1204 shown in FIG. 12A. The conductive regions of the second substrate material 1210 can be arranged such that the conductive regions are positioned to overlap or align with the conductive regions 1204 shown in FIG. 12A, separated by separator material (e.g., the separator material 1208 of FIG. 12A). Any suitable approach can be used to adhere the second substrate material 1210 to the substrate material 1202, including but not limited to adhesive bonding, thermal lamination, or mechanical fastening. In some implementations, a protective layer (e.g., foam, a dielectric material, etc.) may be mounted or coupled to the outer surface of the second substrate material 1210.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the Figures. It should be noted that the orientation of various elements may differ according to other exemplary embodiments, and that such variations are intended to be encompassed by the present disclosure.

Any implementation disclosed herein may be combined with any other implementation, and references to “an implementation,” “some implementations,” “an alternate implementation,” “various implementation,” “one implementation” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, any software implementations of the described methods could be accomplished with standard programming techniques with rule-based logic and other logic to accomplish the various connection steps, processing steps, comparison steps, and decision steps.

The preceding description of the disclosed embodiments is provided to enable any person skilled in the art to make or use the embodiments described herein and variations thereof. Various modifications to these embodiments will be readily apparent to those skilled in the art, and the principles defined herein may be applied to other embodiments without departing from the spirit or scope of the subject matter disclosed herein. Thus, the present disclosure is not intended to be limited to the embodiments shown herein but is to be accorded with the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A method of forming a three-dimensional (3D) tactile sensor, comprising:
providing a first substrate material for the 3D tactile sensor;
defining a set of first conductive regions for the 3D tactile sensor on the first substrate material;
coupling a separator layer between the first substrate material including the set of first conductive regions and a second substrate material having a set of second conductive regions to create a stack; and
forming the stack into a target 3D structure.

2. The method of claim 1, wherein providing the first substrate material comprises selecting the first substrate material from the group consisting of:
thermoplastic polyurethane;
polyethylene terephthalate; and
polyimide.

3. The method of claim 1, wherein defining the set of first conductive regions comprises:
disposing a conductive ink on a surface of the first substrate material, the conductive ink forming the set of first conductive regions.

4. The method of claim 3, further comprising disposing the conductive ink using a screen-printing process and a stencil defining a pattern of traces for the 3D tactile sensor.

5. The method of claim 1, wherein defining the set of first conductive regions comprises:
etching a channel in the first substrate material corresponding to a pattern of traces for the 3D tactile sensor; and
providing a conductive material in the channel.

6. The method of claim 5, wherein etching the channel comprises cutting a portion of the first substrate material using a laser.

7. The method of claim 5, further comprising:
providing a cover layer over the conductive material, the cover layer exposing at least a portion of the conductive material.

8. The method of claim 1, further comprising coupling a flexible printed circuit board (PCB) to at least a portion of the set of first conductive regions.

9. The method of claim 1, wherein forming the stack into a target 3D structure comprises thermoforming the stack using a mold for the target 3D structure.

10. A method of forming a three-dimensional (3D) tactile sensor, comprising:
forming a first substrate material according to a target 3D structure for the 3D tactile sensor;
defining a set of first conductive regions for the 3D tactile sensor on the first substrate material;
providing a separator material over at least a portion of the set of first conductive regions;
and coupling a second substrate material having a set of second conductive regions to the separator material, the second substrate material conforming to a 3D structure of the first substrate material.

11. The method of claim 10, wherein forming the first substrate material according to the target 3D structure comprises:
thermoforming a layer of the first substrate material using a mold corresponding to the target 3D structure of the 3D tactile sensor.

12. The method of claim 10, wherein defining the set of first conductive regions comprises:
depositing one or more conductive traces on a surface of the first substrate material using a 3D dispensing process.

13. The method of claim 10, wherein defining the set of first conductive regions comprises:
defining one or more activated regions on a surface of the first substrate material; and
plating the one or more activated regions with a conductive material.

14. The method of claim 13, further comprising defining the one or more activated regions using a laser according to a pattern of traces for the 3D tactile sensor.

15. The method of claim 10, wherein defining the set of first conductive regions comprises:
providing one or more conductive traces on a surface of the first substrate material using a pad printing process.

16. The method of claim 10, wherein providing the separator material comprises:
depositing the separator material on the portion of the set of first conductive regions using a 3D dispensing process.

17. The method of claim 10, wherein providing the separator material comprises:
coupling a layer of dielectric material to the first substrate material to cover the set of first conductive regions.

18. The method of claim 10, further comprising:
mounting one of the first substrate material or the second substrate material to a backing material.

19. A three-dimensional (3D) tactile sensor, comprising:
a stack comprising:
a first layer of substrate material having a set of first conductive regions,
a separator material coupled to the first layer of substrate material, and
a second layer of substrate material having a set of second conductive regions isolated from the set of first conductive regions by the separator material,
wherein the stack is thermoformed to conform to a target 3D structure.

20. The 3D tactile sensor of claim 19, wherein the separator material comprises one of a dielectric material or a piezoresistive material.
